(19) United States
(12) Patent Application Publication
(10) Pub. No.: US 2003/0054181 A1
(43) Pub. Date: Mar. 20, 2003

(54) Substrate for fluorescence analysis

(76) Inventors: Harold Swerdlow, Saffron Walden (GB); Benoit de Pradier, Aix-en-Provence (FR); Gerald Jesson, Stockholm (SE)

Correspondence Address: JENKENS & GILCHRIST, PC, 1445 ROSS AVENUE, SUITE 3200, DALLAS, TX, 75202, US

(21) Appl. No.: 10/047,053

(22) Filed: Jan. 14, 2002

Related U.S. Application Data
(60) Provisional application No. 60/261,274, filed on Jan. 12, 2001.

(51) Int. Cl. B32B 9/04; B05D 3/02; B05D 3/04

(52) U.S. Cl. 428/457; 428/446; 428/426; 427/378

(57) ABSTRACT

The present invention relates to an improved substrate for use in detection of fluorescence. More specifically the improved substrate exhibits a supported surface layer of silicon dioxide on a silicon support material, on another solid support material, or on a silicon layer supported on another solid support material. The inventive substrate allows for a significantly higher sensitivity to be obtained when used in fluorescence analysis. The invention also relates to a method of preparing the inventive substrate, which substrate in one embodiment of the invention takes the form of silicon a slide exhibiting an oxidized surface. The invention also relates to the application of the inventive substrate in microarray analysis.

### TECHNICAL FIELD OF THE INVENTION

The present invention relates to an improved substrate for use in the detection of fluorescence. More specifically the improved substrate exhibits a supported surface layer of silicon dioxide on a silicon support material, on another solid support material, or on a silicon layer supported on another solid support material. The inventive substrate allows for a significantly higher sensitivity to be obtained when used in fluorescence analysis. The invention also relates to a method of preparing the inventive substrate, which substrate in one embodiment of the invention takes the form of silicon on a slide exhibiting an oxidized surface. The invention also relates to the application of the inventive substrate in microarray analysis.

### BACKGROUND ART

In recent years, interest in microarrays has been exploding among researchers, clinicians, and pharmaceutical companies. Microarray-based approaches promise smaller reaction volumes for thousands of simultaneous analyses, leading to reduced cost and higher throughput. Potential applications of such techniques include genetic, bacterial, and viral disease diagnosis; genome-wide functional analysis (functional genomics); large-scale gene expression and regulation studies; identification of genes and their modification for specific traits, e.g., cancer; forensics, and tissue-typing.

Typically, large numbers of DNA probes are individually immobilized (as a spot) on the surface of a glass slide. A fluorophore is attached to the RNA/DNA target sample, which is then reacted (hybridized) with the DNA probes. Then, the microarray is exposed to laser light corresponding to the excitation wavelength of the dye. Emission light coming from the fluorophore is collected by specialized hardware (an epi-fluorescent scanning detector or CCD-camera based imager), and the results analyzed. The hybridization is typically quite selective, making it possible to quantify, at each spot, the amount of specific homologous RNA/DNA present in the target sample.

At present, glass is one of the key preferred substrate materials upon which various types of microarray analyses can be performed. The types of microarrays include those used for: mRNA expression analysis (probes are individual genes or gene fragments), polymorphism analysis (probes represent individual SNPs), DNA sequencing (probes are individual oligonucleotides), and proteomics (probes are individual protein species). Glass is also a preferred substrate for other types of solid-phase methodologies such as in-situ hybridization, in-situ protein localization, etc. Glass surfaces can be easily treated in order to immobilize different kinds of molecules (DNA, RNA, proteins, ligands, etc.). This material has been extensively used for quite some time, and its chemistry is well understood. However, glass microarrays suffer from high background fluorescence, poor surface uniformity, and poor reproducibility from slide to slide.

A key to successful implementation of microarray-based approaches is the ability to detect small concentrations of fluorophore. By decreasing the limit of detection, it becomes possible to use less biological material, to detect genes present in lower abundance, and/or to get a better measurement of the true concentration of a species, all of which are very important to the successful application of these methods. Consequently, numerous attempts have been made aiming at lowering the detection limits, such as for example by selecting a dye with a higher quantum efficiency, improving the chemistry of the surface binding, building a more efficient detector, etc. However, these developments are generally costly and show only small incremental gains.

Accordingly, it is an object of the present invention to further improve the previously mentioned detection limits.

This object has been achieved by means of a substrate for fluorescence analysis, which exhibits a supported surface layer of silicon dioxide.

According to another aspect the claimed invention also relates to method of preparing the inventive substrate, comprising the steps of:

a) providing a silicon layer;

b) oxidizing a surface of the silicon layer in an oxygen containing atmosphere under a high temperature, preferably from 600 to 1300° C., more preferably from 950 to 1050° C.

### SUMMARY OF INVENTION

An improved substrate has been developed to replace ordinary glass slides used for DNA micro-array analysis based on laser-induced fluorescence detection. The new substrate can, for example, be made from a silicon wafer by oxidation of a surface thereof at high temperature in an oxygen flow With this method a thin layer of silicon oxide, with a thickness ranging between 20 and 3000 nm, can be formed onto the silicon surface. The oxidized wafer can then be diced into desired dimensions, such as for example slides. The high signal oxidized silicon layer of the invention can also be attached to a backing material, such as for example a plastic material, a metallic material, or glass.

The sensitivity can be increased 2 to 30 times when using oxidized-silicon slides, as compared to ordinary glass slides. The inventive solid phase support could also be used not only in functional genomics analysis but also in many other applications. It has the advantage of being made according to common and inexpensive micro-fabrication processes.

### BRIEF DESCRIPTION OF THE ATTACHED DRAWINGS

FIG. 1 shows oxidized-silicon slides according to one embodiment of the present invention is shown.

FIG. 2 shows a schematic representation of an array deposited onto a silicon slide having an oxidized surface according to the present invention.

FIG. 3 shows the signal ratio for both Cy3-and Cy5-labeled PCR products vs. oxide thickness is shown.

FIG. 4 shows signal intensity (less background) divided by concentration versus concentration for both Cy3-(A) and Cy5-(B) labeled fragments.

FIG. 5 shows the signal ratio as a function of oxide thickness.

FIG. 6 shows the signal/exposure time (A) and signal-to-noise ratio (B) measured on a fluorescence microscope.

FIG. 7 depicts the relative signal intensity after hybridization on poly-L-lysine coated slides.

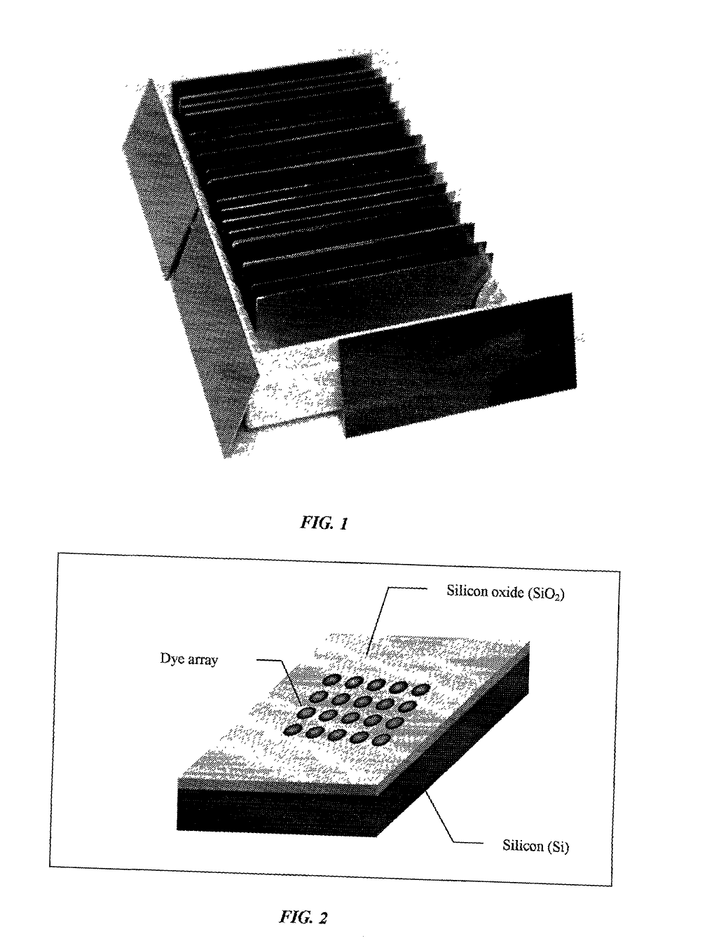

### DETAILED DESCRIPTION OF THE INVENTION

The present inventors have surprisingly found that by oxidizing a silicon surface, the signal intensity in fluorescence measurements was significantly increased over the levels seen on conventional glass slides. The signal-to-noise ratio was also increased. This surface treatment would have been expected to increase the signal-to-noise ratio for fluorescence measurements by bringing the signal back to the same level as glass, while keeping the noise at a minimum.

Sensitivity improvements of up to 30 times have been measured with the inventive oxidized-silicon slides compared to ordinary glass slides. The inventors have found that the performance of the slides may depend on silicon doping (Negative (N) or Positive (P)), oxide thickness, the process used to oxidize the surface (dry, wet oxidization), fluorophore used (Cy3, Cy5) and fluorophore concentration.

While not wishing to be bound to any theory, it is assumed that the basis for the observed increase in signal on the oxidized-silicon slides as compared to both silicon and glass substrates is of an optical nature.

Signal intensity increases continuously with dye concentration in the experiments, but is not linearly proportional to dye concentration. That is, the performance improvement with respect to conventional glass slides is greater at higher concentrations. This fact notwithstanding, even very dilute dye (and dye-labeled) spots give much more signal on an oxidized-silicon slide than on a regular glass slide.

It was also found that the commonly observed phenomenon of decreasing signal intensity with subsequent scans (photobleaching—a photochemical destruction of the dye due to prolonged exposure to an intense laser beam), is less pronounced with oxidized-silicon slides.

Oxidized-silicon according to the invention performs far better than glass as a substrate for microarrays and other fluorescence-based measurements. As will be seen from the Example below, it is apparently harder to obtain the same level of enhancement of the signal with hybridized fluorescently-labeled cDNAs as with dyes or dye-labeled PCR products.

The novel type of substrate, which according to one embodiment has the form of a slide, has potential in any application where fluorophores are excited and detected on solid supports. This includes any application in which dyes or dye-labeled molecules currently are spotted or otherwise placed onto glass surfaces. Potential applications include all types of microarray analysis, fluorescence in-situ hybridization (FISH), in-situ protein localization, DNA sequencing chips (e.g., sequencing by hybridization—SBH), arrayed primer extension (APEX), microsequencing, mutation detection and diagnostics, single nucleotide polymorphism (SNP) analysis, dynamic allele-specific hybridization (DASH), pyrosequencing, numerous microchip-based electrophoretic (and/or capillary) systems, surface-based sensors, immunological assays, single-molecule detection systems, etc.

In an embodiment of the substrate of the invention, the surface layer of silicon dioxide is supported by a silicon layer, i.e. a silicon layer having an oxidized surface, such as for example an oxidized silicon wafer, or a thicker self-supporting silicon layer having an oxidized surface.

According to another embodiment of the substrate of the invention, the high signal silicon layer of the invention is attached to a backing or supporting material, such as a plastic material, a metallic material, or glass material. The use of a backing or support material is for example convenient in applications where a larger detection surface is required, and/or where a thinner silicon layer, such as a thin wafer, is desirable. Such embodiment will also be necessary when the silicon layer used is not self-supporting, such as when a very thin silicon layer is used. It will be understood that the silicon layer in such a case can be essentially comprised of silicon dioxide, or there may be any fraction of the silicon layer used remaining unoxidized between the surface of the supporting material.

In a preferred embodiment the supporting material is flat. In another preferred embodiment the substrate is circular. A specific example is a compact disc (CD)-shaped plastic backing material exhibiting the high signal silicon layer.

Accordingly, in one embodiment of the method of the invention, a surface of a silicon layer is first oxidized, and thereafter said layer is attached to a backing or supporting material.

According to another embodiment of the method, a silicon layer is deposited or attached to a supporting or backing material, such as the above-mentioned materials, and thereafter, the surface of the silicon layer is oxidized.

The method of attachment is not critical according to the invention.

In an alternative embodiment of the method of the invention, especially in cases where a very thin silicon layer is desirable, the silicon layer can be attached to the supporting or backing material by means of deposition of silicon. Such deposition can be accomplished by any currently known methods in the art of depositing silicon on another material. Thereafter, the surface of the deposited silicon layer is oxidized.

The oxidation of the method of the present invention can also be carried out by means of laser treatment.

According to a further embodiment of the method, glass beads conventionally used in various analytical systems can be fabricated from oxidized-silicon according to the present invention. Other substrates similar to silicon that may be used include any materials known in the art, for example, germanium, indium, etc. Other silicon or other substrate surface coatings known in the art, for example, nitrides, carbides, TiO₂, etc., may also prove to be useful for the purposes identified here.

EXAMPLE

### Preparation of Slides According to a Preferred Embodiment of the Invention

In this example a series of oxidized-silicon slides according to the invention were prepared and compared with non-oxidized slides. Single-crystalline silicon wafers (4 in. diameter, thickness 525 μm—about half that of a standard microscope slide) were used for the fabrication of slides, although other wafers known in the art could also be used. Their properties are specified in Table 1.

TABLE 1
Wafer properties

| | Orienta- | | | | | Slide |
|---|---|---|---|---|---|---|
| | tion | | Resistivity | Manu- | | thickness |
| Doping | (deg) | Dopant | (ohm/cm) | facturer | Growth | (μm) |
| Positive | <100> | B | 1-100 | Okmetic | CZ | 525 ± 25 |
| Nega- | <100> | P | 0.01-100 | Okmetic | CZ | 525 ± 25 |
| tive | | | | | | |
| Positive | <100> | B | 300 | Topsil | CZ | 525 ± 15 |
| (low) | | | | | | |

In this example the wafers were oxidized in a KOYO-Lindberg oven, μTF6, using dry (oxygen and nitrogen) or wet (oxygen and nitrogen and steam) oxidation methods, yielding layers of different thickness of silicon oxide (quartz). Generally, the wet oxidation method gives thicker oxide layers when used with silicon substrates than equivalent treatments with the dry method. The temperature of oxidation can be between 600 and 1300° C., preferably between 950 and 1050° C. In the example, a temperature of 1000±50° C. was used. The thickness of the silicon oxide layer varied as a function of the time of oxidation, which varied between 1 and 20 hr. The oxide thickness was measured, using a Leica optical profilometer. The oxidized wafers were then cut to the length and width of a conventional microscope slide (76 mm×26 mm) using a dicing saw (model 1006—Micro Automation, Inc.) fitted with a diamond-coated blade. It was possible to obtain two slides from a single round 4 inch wafer. Table 2 lists the slides, which subsequently were evaluated as will be described in the following.

TABLE 2
Slides number and oxide thickness obtained (nm)

| N | | P | | | | | | | | | | | |
|---|---|---|---|---|---|---|---|---|---|---|---|---|---|
| *No | | *No | | N | | P | | N | | P low | | P | |
| oxidation | | oxidation | | Wet | | Wet | | Dry | | Dry | | Dry | |
| III-I | 0 | I | 0 | II-I | 134 | V | 92 | I-I | 28.5 | W I | 105 | V-I | 92 |
| | | III-II | 0 | II-II | 152 | V′ | 130 | I-II | 55.4 | W II | 220 | I-IV | 127 |
| | | | | II-XI | 220 | VI | 218 | I-III | 95.5 | W II | 307 | V-II | 134 |
| | | | | II-III | 287 | VII | 278 | I-VI | 131 | | | V-III | 138 |
| | | | | II-XII | 335 | III | 280 | I-VII | 219 | | | V-IV | 186 |
| | | | | II-IV | 483 | VIII | 485 | I-V | 309 | | | V-V | 270 |
| | | | | II-XIII | 680 | IX | 680 | I-VIII | 423 | | | V-VI | 311 |
| | | | | II-V | 1464 | IV | 999 | | | | | V-VII | 370 |
| | | | | II-XIV | 1470 | II | 1900 | | | | | | |
| | | | | II-VI | 1882 | | | | | | | | |
| | | | | II-XV | 2352 | | | | | | | | |
| | | | | II-VII | 2730 | | | | | | | | |

*Not according to the invention

The silicon slides listed in Table 2 were subsequently evaluated and compared to conventional glass slides in the Tests 1 to 4 as described hereinafter. Predetermined amounts of fluorescently labeled target molecules were hybridized to probes constituting the products of a PCR operation, which probes in a preceding step had been spotted onto the slides. The signals detected from the fluorescently labeled target molecules were then compared.

In measurements used in the different micro-array analyses, in which the substrate of the invention can be used, and in the measurements used for the evaluation in the tests, background interference is partly a result of fluorescence from impurities in the material, and also derived from dirt and dust on the surface. Generally, the materials used themselves have essentially no native fluorescence. For example, fused-silica (quartz), by virtue of its purity, has a lower background fluorescence than ordinary glass. In order to keep the surface fluorescence as low as possible, a very careful cleaning of slides is critical. Accordingly, both oxidized-silicon slides and standard glass slides (Menzel-Glaser #01 1101) used for comparison were cleaned before testing.

A suitable cleaning procedure is, for example, one consisting of the following steps: short soak in acetone at RT, wipe the slide carefully, wash in 5% HCl, wash using powder-free gloves in 1% SDS, rinse in running tap water, short soak in a mix of 20 g NaOH, 86 ml of dH₂O and 114 ml of ethanol, wash vigorously in dH₂O, and dry under a nitrogen flow. This cleaning procedure was used for all substrates.

Unoxidized silicon slides (not according to the present invention) show a severe reduction in signal strength compared with glass slides. For example, arrays of diluted Cy3-dUTP (100 nM/l) were spotted on top of uncoated cleaned pure silicon slides (Table 2; numbers I, III-I, III-II) and a conventional glass slide. Signal intensity and signal-to-noise (S/N) ratio were quantified. Compared to glass, it was found that pure silicon slides exhibit lower noise, as expected, but also suffer from very low signal strength. The combination of these two effects leads to a lowered S/N.

However, in initial testing on oxidized-silicon slides, the noise level was surprisingly found to be similar for the oxidized-silicon and the glass slides. On the other hand, the signal obtained was far greater for the oxidized-silicon slide than for the glass slide. For example, for an uncoated oxidized-silicon slide (number III—280 nm P wet) prepared as described above, the S/N ratio was observed to be 12-20 times better than glass measured on both the commercial microarray scanner and on the CCD-camera based imaging fluorescent detector.

However, the N-doped (phosphorous) silicon slides were found to exhibit a weaker signal than their P-doped (boron) counterparts. This difference was eliminated when the slides were coated with poly-L-lysine. Before the testing below, the slides were coated with poly-L-lysine, as is customary in the art of microarray production, to allow the non-covalent binding of DNA to the surface. Other coatings known in the art to allow binding of macromolecules (D)NA, RNA, protein, ligands, etc.) to a planar surface by ionic, hydrophobic, covalent, or other means, may also be used with the present invention.

The cleaned oxidized-silicon and glass slides used for microarray applications in the evaluation were coated with poly-L-lysine by incubation in a poly-L-lysine solution (67 ml dH₂O, 8.4 ml Poly-L-Lysine stock solution, 8.4 ml PBS buffer) with agitation at room temperature for 45 minutes. The slides were then washed vigorously in dH₂O, dried in a tabletop centrifuge at 700 rpm for 5 minutes (model B4, JOUAN) and placed in an oven at 45° C. for 10 minutes. The coated slides were aged in a plastic box at room temperature for at least 20 hours before being used. Tables 3 and 4 list the chemicals, buffers and oligonucleotides used for poly-L-lysine coating and in the subsequent testing.

TABLE 3
List of chemicals

| Chemical | Origin |
|---|---|
| water | Deionized using a BARNSTEAD Nanopure |
| | Infinity ultrapure water system |
| sodium hydroxide | Pellets, pro-analysis from Kebo Lab—Merck |
| | # 7.7437-1 |
| ethanol | Kemetyl 99.5% |
| hydrochloric acid | Sigma # 7020 |
| 10x PBS buffer | Home made (38.25 g NaCl, 3.6 g Na₂HPO₄, |
| | 1.05 g KH₂PO₄, pH 7.3, volume adjusted to |
| | 500 ml with H₂O) |
| poly-L-lysine stock | Sigma # 8920 |
| solution | |
| sodium Dodecyl Sulfate | Pharmacia Biotech # 17-1313-01 |
| (SDS) | |
| sodium borate | Pharmacia Biotech # 17-1322-01 |
| anhydrous 1-methyl-2- | Aldrich # 32,863-4 |
| pyrolidinone | |
| succinic anhydride | Aldrich # 23,969-0 |
| 20x SSC | Home made (175.3 g NaCl, 88.2 g sodium |
| | citrate, 800 ml H₂O, volume adjusted to 11 |
| | with H₂O) |
| acetone | Kebo Lab # 152966P |
| ethidium bromide | Pharmacia Biotech # 17-1328-01 |
| agarose powder | FMC # 50182 |
| 1 M magnesium chloride | |
| KCl | Sigma # M-1028 |
| Trizma base | Sigma # P-9541 |
| Trizma HCl | Sigma # T-8524 |
| | Sigma # T-7149 |

TABLE 4
List of biological molecules

| Biological molecule | Origin |
|---|---|
| GAPDH cDNA template | Clontech #9805-1 |
| M13 SS DNA template | home-made from plasmid prep of m13 RF clone |
| Primers (5′ to 3′): | Interactiva —Germany (each diluted to |
| HS303-5′NH2: ATA CGC AAA | 100pmol/μl) |
| CCG CCT CTC CC | |
| HSU1-5′cy3: GTT GTA AAA | |
| CGA CGG CCA GT | |
| HSU1-5′cy5: GTT GTA AAA | |
| CGA CGG CCA GT | |
| GAIPDH1: GCG CTG AGT ACG | |
| TCG TGG AGT G | |
| GAPDH2: TCT TCC ACC ACT | |
| TCG TCC GCA G | |
| PCR buffer | Home made (10 ml 100 mM Tris buffer pH 9.0, |
| | 3.73 g 500 nM KCl, 1.5 ml MgCl₂ 15 mM + fill |
| | up to 100 ml with dH₂O) |
| Taq polymerase | Promega # M1665 |
| human brain mRNA | Intermedica # 6516-1 |
| 0.5ug/ul oligo-dT | Gibco BRL # Y01212 |
| first strand buffer | Gibco BRL # Y00146 |
| Ultrapure dNTP set (100 mM each) | Pharmacia Biotech # 27-2035-01 |
| superscript II reverse transcriptase | Gibco BRL # 18064-014 |
| Cot1 human DNA | |
| TE buffer | Gibco BRL # 15279-011 |
| PolyA RNA | Home made (100 mM Tris, 1 mM EDTA, pH |
| | 7.5) |
| yeast tRNA | Pharmacia Biotech # 27-7836 |
| Cy3 and Cy5-labeled dUTP | Gibco BRL # 15401-029 |
| | Pharmacia Biotech PA 53022/PA 55022 |

### Preparation of Polymerase Chain Reaction (PCR) Product Probes

The PCR products used for probes in the different tests described below were either Cy3- or Cy5-labeled (M13 DNA) and unlabelled (GAPDH cDNA). In all cases, the PCR reaction mix contained: 10 μl of M13 or GAPDH template at the respective concentrations (1.8 pg/μl and 1.64 pg/μl), 10 μl of each of 2 primers at 5 μM (H303-5′NH2 and HSU1 for M13 or GAPDH1 and GAPDH2 for GAPDH), 10 μl of dNTP mix (each dNTP nucleotide at 2 mM), 10 μl of home-made 10× PCR buffer, 0,8 μl of 5 unit/μl Taq Polymerase and 49.2 μl of dH₂O. The reaction mix was thermally cycled in a model PTC-100 (MJ Research, Inc) according to the following programs: M13—95° C. for 5 minutes, followed by 30 cycles of 92° C. for 20 seconds, 58° C. for 20 seconds, 72° C. for 20 seconds, followed by 72° C. for 5 minutes, and then followed by a hold at 4° C.; GAPDH—92° C. for 5 minutes, followed by 30 cycles of 92° C. for 20 seconds, 64° C. for 20 seconds, 74° C. for 20 seconds, followed by 74° C. for 5 minutes, and then followed by a hold at 4° C.

The PCR mix was purified using a QIAquick PCR purification kit (Qiagen #28104) according to the manufacturer's protocol; elution was in 50 μl of dH₂O.

PCR products pooled from multiple reactions were analyzed on a 1.5% w/v agarose gel containing 100 μg/ml ethidium bromide. An estimation of the PCR product concentration was performed by comparison of the proper bands with those of a marker DNA standard. PCR products were diluted 1:1 in DMSO prior to spotting.

### Preparation of the Cy3/Cy5 Human Brain cDNA Target Sample

To 0.5 μl of human brain mRNA (1 μg/μl) was added 4 μl of oligo dT and 10.5 μl of DEPC water. The reaction was heated to 70° C. for 10 min before being cooled on ice. 15 μl of labeling reaction mix (6 μl of 5× first strand buffer, 3 μl of 0.1 M DTT, 0.6 μl of unlabeled dNTPs (each one at 2 mM), 3 μl of Cy3 or Cy5-labeled dUTP, 2 μl of 200 unit/μl Superscript II reverse transcriptase and 0.4 μl of DEPC treated water) was added for both Cy3 and Cy5 dye-labeled reactions. The mix was incubated at 42° C. for 1½ hr. The RNA was then degraded by addition of 15 μl of 0.1 N NaOH solution and by heating at 70° C. for 10 minutes. 15 μl of 0.1 IN HCl solution was added, and subsequently 20 μl of 1 μg/μl human cot1 DNA. The volume was brought up to 500 μl with TE buffer, and the mix was concentrated and desalted using a Centricon-30 microconcentrator (Amicon) centrifuged at 12000 rpm. Labeled target samples were recovered in a volume of approximately 50 μl.

The Cy3 and/or Cy5 concentrates were pooled together and the volume brought to 500 μl with TE buffer before a second Centricon-30 purification was used to get a final volume of approximately 7 μl.

Before use in the hybridization in tests 1, 2 and 3, each target was adjusted to a final volume of 9.5 μl with DEPC treated water after the addition of 1 μl of 10 μg/μl poly A RNA or poly dA solution and 1 μl of 3 μg/μl yeast tRNA. Finally, 2.1 μl of 20×SSC and 0.35 μl of 10% SDS were added. The resulting 12 μl target sample was used for hybridization to arrayed GAPDH PCR product probes.

### Scanning

The slides were read using three different detection systems. In a GMS 418 array scanner, in which the optics are optimized for 1 mm thick glass microscope slides, two oxidized-silicon slides (525 nm thick) were placed on top of each other in order to achieve a good signal.

A novel CCD-camera based imaging fluorescent detector developed by B. de Pradier and H. Swerdlow was also employed. The slide is directly illuminated by a 488 nm Argon-ion laser beam, and the emitted light is captured by a large format lens. Captured light is spectrally filtered using a holographic notch filter to eliminate scattered laser light. The signal is imaged onto a CCD camera and the resultant image taken in a single exposure.

Additionally, a commercial full-field fluorescence microscope from Leica (model DMRXA) was used. Excitation wavelength was set at 560 nm, and the visible range of emission wavelengths were studied.

In order to compare signal and background levels accurately, and to avoid the effects of photobleaching, all slides were scanned the same number of times at the same laser power.

### Analysis of Results

The images obtained from the scanners were analyzed using ArrayVision software (Imaging Research, Inc). No signal processing was performed prior to analysis. Signal intensity was integrated over the entire spot area for each spot of the array; background was measured by averaging the values of an array outside the borders of the arrayed spots. Signal-to-noise ratio (S/N) was defined as the integrated signal (less the background) divided by the noise (defined as the standard deviation of the values of the background array)

### Test 1

In this Test, several oxidized-silicon and glass slides were coated with poly-L-lysine and spotted with arrays of PCR products. The dye labels used were both Cy3 and Cy5. The stock concentration of these dye-labeled PCR products was about 100 ng/μl, as estimated from agarose gel electrophoresis. Products were spotted at 5 ng/μl in 50% DMSO.

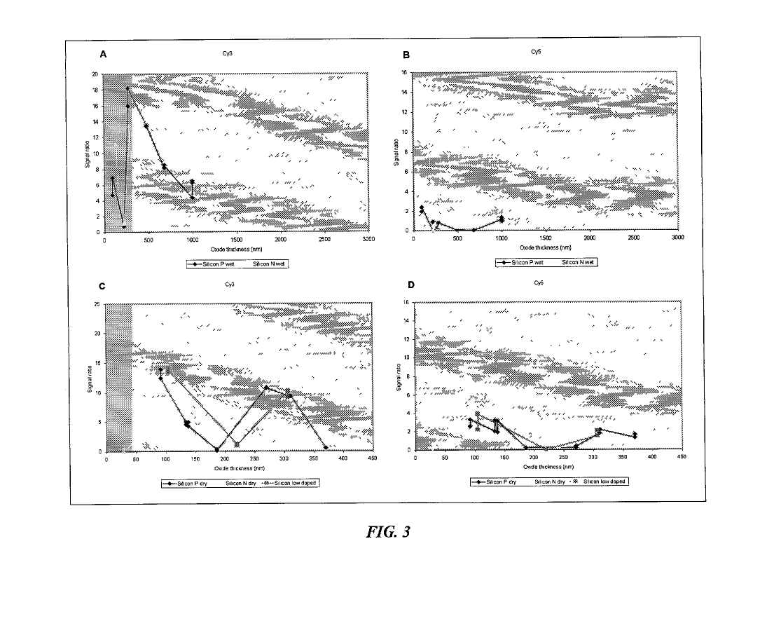

Noise was similar for both oxidized-silicon and glass slides. We defined the “signal ratio”, as the ratio of signal intensity (less the background) for the oxidized-silicon slides divided by a glass slide (measured for the same dye label Cy3 or Cy5). In FIG. 3 is shown the signal ratio for both dye-labeled PCR products vs. oxide thickness. Signal ratio values range as high as 20 for Cy3 and 14 for Cy5. In FIGS. 3A vs. 3C and 3B vs. 3D, the effect of changing the method of oxidation (wet or dry) can be seen. We currently believe the two methods to be equivalent. The silicon thickness giving the best signal ratios is not the same for Cy3 and Cy5 (compare FIGS. 3A and 3C to 3B and 3D, respectively). The curves may be periodic with respect to frequency. Maxima of signal ratio can be seen at about 100 nm, 280 nm, 500 nm and 1900 nm for Cy3; 130 nm, 320 nm, and beyond 2700 nm for Cy5. There appears to be no profound effect of changing the dopant material from boron (P) to phosphorous (N), nor can a difference be seen when using the low-doped substrates.

It is interesting to compare the peaks in signal ratio as a function of oxide thickness seen, e.g., in FIG. 3, with the maximum excitation (or emission) wavelength of the dye used (554 nm for Cy3, 650 nm for Cy5). The locations of the peaks are generally proportional to the wavelength (or more likely the frequency). This observation points to a higher likelihood for an optical rather than a chemical or physical basis for the increase in signal we have observed on oxidized-silicon slides of the invention compared to both silicon and glass substrates.

### Test 2

In another experiment the poly-L-lysine-coated slides were spotted as described above with Cy3- and Cy5-labeled M13 PCR products prepared as above and diluted at various concentrations.

The stock concentration of the spotted products was about 100 ng/μl, as estimated from agarose gel analysis. Stock samples were diluted 1:20, 1:50, 1:100, 1:200, 1:300, and 1:400 in 50% DMSO. Signal intensity, background noise, S/N and signal ratios were calculated for all slides and dyes used. Background noise and signal intensity were quite reproducible for both silicon and glass slides.

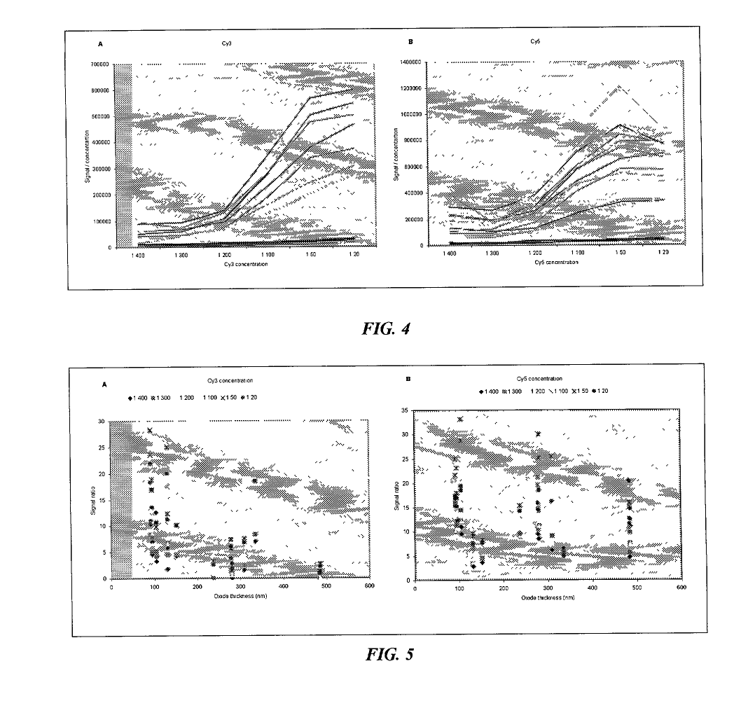

FIG. 4 shows signal intensity (less background) divided by concentration versus concentration for both Cy3-(A) and Cy5-(B) labeled fragments. If the number of photons detected by the scanning system were proportional to the quantity of dye, then these graphs should be horizontal lines (assuming the photodiode of the detector is linear). It can clearly be seen that signal intensity is not linearly related to the concentration of the dye. Signal is proportionally higher at higher concentrations.

FIG. 5 shows the signal ratio (as defined previously) as a function of oxide thickness, for all slides, both dye labels, and all the dye dilutions used. It can be seen that signal ratios depend on dye concentration, peaking at about 30× for both Cy3 (A) and Cy5 (B) at a 50× dilution. Signal ratio maxima do not generally occur at the same silicon-oxide thickness for Cy3 and Cy5, as observed previously. However, two slide types work well for both dyes: V-I (92 nm P dry) and I-III (95 nm N dry). Types III (280 nm P wet) and W-I (105 nm P dry) work very well with Cy3 only.

### Test 3

Arrays of M13 Cy3-labeled PCR products in 50% DMSO prepared as described above were spotted on both standard glass slides and oxidized silicon W-I slides, each coated with poly-L-lysine.

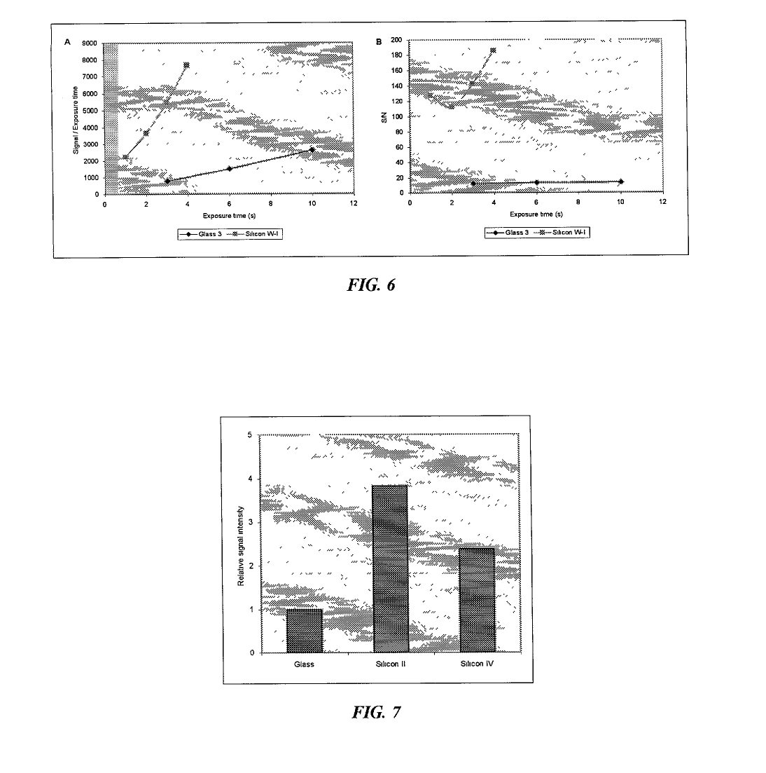

Images were taken with a full-field fluorescence microscope (Leica). Amplification factor and exposure time varied. As can be seen from FIG. 6, signal was found to be more than 6 times better for the oxidized-silicon slides as compared to the glass slides, while the S/N was 10 times better.

Thus, results found with the commercial Leica full-field fluorescence microscope corroborate those observed with the GMS confocal scanning microarray detector.

### Test 4

A typical microarray DNA-DNA hybridization protocol was used to test the oxidized-silicon slides (types II and IV). The slides were coated with poly-L-lysine, spotted with unlabelled GAPDH PCR products, post-processed and hybridized to fluorescently-labeled human brain derived cDNA.

The unlabelled GAPDH PCR products prepared as described above were spotted onto each slide using a model 417 arrayer from Genetic Microsystems (GMS). Concentration of the GAPDH products used for spotting was 100 ng/μl in 50% DMSO. The DNA was cross-linked to the slides immediately after spotting using a Stratalinker (Stratagene) set at 65 mJ. For post-processing, the slides were rinsed once in 0,1% SDS for 5 min at room temperature before surface blocking-plunging and shaking the slides for 20 minutes in a solution of 3.14 g of succinic anhydride, 185 ml of 1-methyl-2-pyrrolidinone and 14.3 ml of sodium borate. The slides were then rinsed and agitated 5 times 1 min each in dH₂O. The DNA is then denatured in boiling dH₂O at 95° C. for 2 min before drying by centrifugation at 550 rpm for 5 min. The slides can be stored at room temperature for at least a month.

Thereafter, hybridization was achieved by placing the Cy3- or Cy5-labeled human brain cDNA target sample on top of the dried microarrayed PCR product probes, and covering them with a standard microscope cover slip. The slides were then placed into a sealed plastic box filled at the bottom with a small quantity of 3× SSC in order to maintain a stable humid atmosphere The hybridization chamber was left overnight (18 hours) in an oven at 65° C. The slides were washed by immersion and agitation at room temperature for 5 min in 2× SSC with 0.1% SDS, followed by 1× SSC, and 0.1× SSC. Finally the slides were dried by centrifugation at 550 rpm for 5 min before scanning.

As shown in FIG. 7, the signal is between 2 and 4 times greater on oxidized-silicon slides as compared to the glass slides.

A second experiment (not shown) gave a value of 10 times more signal for the oxidized-silicon slides according to the present invention.

1. A substrate for fluorescence analysis, comprising a surface layer of silicon dioxide attached to a support layer.

2. The substrate of claim 1, wherein the surface layer is self-supported, i.e., the support layer is a silicon layer.

3. The substrate of claim 1, wherein the thickness of the silicon dioxide layer is from 20-3000 nanometers.

4. The substrate of claim 1, wherein the support layer is composed of material selected from the group consisting of plastic, metal and glass.

5. The substrate of claim 4, wherein a layer of unoxidized silicon remains between the surface layer of silicon dioxide and the support layer.

6. The substrate according to claim 1, wherein the substrate has the size and shape of a microscope slide or a compact disc (CD).

7. The substrate according to claim 1, wherein the substrate is in the shape of tubes, rods or beads.

8. The substrate of any of claims 1-7, wherein the substrate is used in a method of detection based on fluorescence.

9. The substrate of any of claims 1-7, wherein the substrate is used in a method based on microarray analysis.

10. The substrate of claim 9, wherein the microarray analysis is a DNA microarray analysis.

11. A method for preparing a substrate for fluorescence analysis exhibiting a surface layer of silicon dioxide attached to a support layer comprising the steps of:
a) providing a silicon layer; and
b) oxidizing a surface of the silicon layer in an oxygen containing atmosphere under a high temperature ranging from 600 to 1300° C.

12. The method of claim 11, wherein the high temperature ranges from 950 to 1050° C.

13. The method of claim 11, wherein the silicon layer is attached to the supporting layer before oxidation.

14. The method of claim 11, wherein the silicon layer is attached to the support layer after oxidation.
